(19) United States
(12) Patent Application Publication
(10) Pub. No.: US 2012/0233038 A1
(43) Pub. Date: Sep. 13, 2012

(54) Watch Exchange

(76) Inventor: Paul Altieri, Huntington Beach, CA (US)

(21) Appl. No.: 13/477,510

(22) Filed: May 22, 2012

Related U.S. Application Data
(60) Provisional application No. 61/577,865, filed on Dec. 20, 2011.

(51) Int. Cl. G06Q 30/00

(52) U.S. Cl. 705/27.2

(57) ABSTRACT

A watch exchange system is presented. The system includes a storage medium for storing data relevant to buying and selling watches. The system also includes a processor and executable code for electronically displaying the data to a consumer via an interface. The interface shows an image of a type of watch, with a buy price and a sell price just below the image. Below the buy price and sell price are a user-selectable buy object and a user-selectable sell object. The horizontal space between the user selectable objects is less than the length of either object.

This application claims the benefit of priority to U.S. provisional application serial number 61/577,865 filed on Dec. 20, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is watch exchanges.

### BACKGROUND

People have been buying and selling watches for centuries and today there are numerous internet websites that allow consumers to buy and sell used watches. Just like with many used goods, the fair market value of used watches is often difficult to determine due to secret sales and lack of comparable sales data. This problem is further exacerbated in the used watch market since used watch traders hide their buying prices in order to hide their profit margins. As a result, used watch prices (both buy and sell prices) tend to fluctuate drastically from one exchange to the next, depending on the buyer's and seller's respective experience and bargaining power. Current used watch traders have failed to provide a platform for exchanging used watches in a transparent manner (e.g., buy and sell prices are publicly presented) using a format that is readily understood by the general public.

As used herein, the term “watch exchange” refers to buying and/or selling watches. As used herein, “used watch traders” refers to people, businesses, and entities that regularly engage in the buying and selling of used watches. As used herein, “consumers” refer to people, business, and entities that engage a used watch trader to either buy or sell a used watch.

Goods other than used watches have been exchanged using a transparent platform for years. For example, various commodities such as gold, oil, foreign currencies, stocks, and bonds are commonly exchanged in a market where current buy and sell prices are publicly known. Such transparency helps to establish fair market values and increases consumer trust when engaging a new trader for the first time.

Numerous systems for trading commodities via the internet are known. See for example: Japanese Patent Application Nos. 2006053868, 2005100059, 2002183506; U.S. Pat. No. 7440913; U.S. Patent Application Publication No. 20040024680; and Chinese Patent Nos. 1388461, 1305170, 1213915.

It has yet to be appreciated that systems and interfaces for trading used watches in a transparent manner can be presented such that the consumer can readily understand the functionality and purpose of the system/interface.

Thus, there is still a need for systems, interfaces, and methods for trading used watches in a transparent manner.

### SUMMARY OF THE INVENTION

Recently, the applicant has made great efforts to provide a transparent platform for exchanging used watches over the internet. Unfortunately, consumers (e.g., website visitors) are frequently confused by the presentation of buy and sell prices of used watches due to the fact that used watches are not conventionally traded in a commodity-type manner (i.e., in a transparent nature). Interestingly, the format and layout used for presenting buy and sell information is very important and significantly impacts whether a consumer will quickly grasp the concept of a buying and selling used watches via an electronic interface in a transparent manner. It unexpectedly turns out that presenting related data in a vertical manner and using tight spacing between buy and sell links can greatly increase the consumer's ability to understand the purpose of the interface.

The inventive subject matter provides apparatus, systems and methods in which a system for buying and selling used watches includes a storage medium, processor, and executable code. The storage medium (e.g., hard drive, database) contains a plurality of watch objects that represent data about used watches. The processor is communicatively coupled with the storage medium and executable code. The code is configured to present used watch information to a user via an interface (e.g., electronic display such as a computer screen). The information includes an image of a watch, a title, a buy price, a sell price, a buy link, and a sell link. However, it is contemplated that any information relevant to buying and selling used watches can be displayed in addition to the information mentioned above.

The watch information is displayed as follows: (1) the buy price and sell price are presented side-by-side and spaced apart by a distance no greater than either length of the buy price and sell price; (2) the buy price and sell price are located directly below the image; and (3) the buy link and sell link are located directly below the buy price and sell price, respectively.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an illustration of one embodiment of a watch exchange interface.

FIG. 2 is an illustration of another embodiment of a watch exchange interface.

FIG. 3 is an illustration of one embodiment of a search tool.

FIG. 4 is a schematic of a watch exchange system.

### DETAILED DESCRIPTION

It should be noted that while the following description is drawn to a server-based watch exchange system, various alternative configurations are also deemed suitable and may employ various computing devices including interfaces, systems, databases, agents, peers, engines, controllers, or other types of computing devices operating individually or collectively. One should appreciate that computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As it turns out, the presentation of buy and sell prices, along with the image of a particular watch model/type, is especially influential in assisting a consumer with understanding the functionality and purpose of a watch exchange interface. The general purpose of the interface is to provide a transparent platform for exchanging used watches. In other words, the interface provides consumers with the buy and sell prices being offered by a used watch trader in a manner that allows the consumer to quickly see both the buy and sell price simultaneously.

FIG. 1 shows an interface 100 that includes six different boxes. Each box presents information related to a type of watch. The information can be used to assist a consumer in buying and/or selling a watch. For example, box 105 includes a watch image 110, title 115, and a description 120. Image 110 is a substantially real-life depiction of a specific watch. Title 115 provides a brief summary of the watch shown in image 110 (e.g., model, type, brand, manufacturer) and description 120 provides detailed information about the watch (e.g., item number, model number, quantity of watches in inventory, condition of watches, source of watches, year of manufacture, date entered into inventory, chain of title verification, customer reviews, etc.). Towards the bottom of box 105 is a buy option 125 and a sell option 130 (e.g., a user-selectable object such as a hyperlink). To the immediate right of buy option 125 is a price and to the immediate right of sell option 130 is a sell price. In embodiments where interface 100 is displayed on a monitor screen via a network, buy option 125 and a sell option 130 preferably comprise hyperlinks that send the consumer to a different interface that facilitates buying and/or selling the watch selected. To the right of buy option 125 is a buy price and to the right of sell option 130 is a sell price. These are the prices at which the owner or manager of interface 100 (i.e., watch trader) is willing to buy and/or sell the respective watch. Alternatively, the displayed prices could represent the price offers of third parties. In this embodiment, the owner or manager of interface 100 acts as a broker and facilitates communication between different parties. The owner of manager of interface 100 could have contractual relationships with the third parties in order to guarantee the displayed prices for a certain period of time.

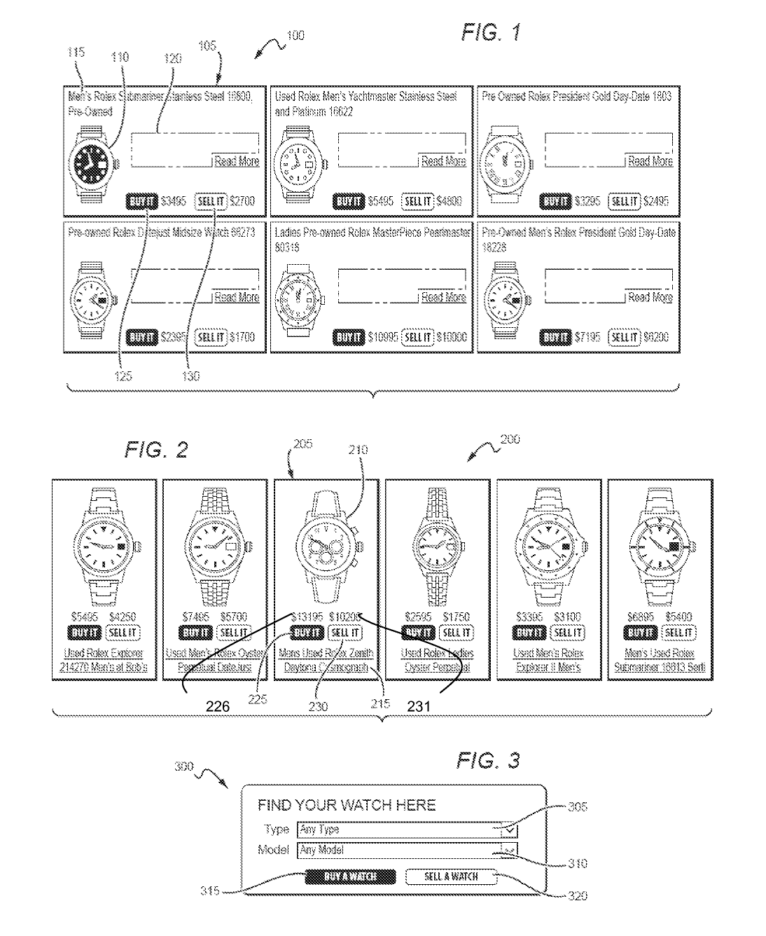

FIG. 2 shows an interface 200. Interface 200 is similar in functionality to interface 100. However, the layout of information in interface 200 is slightly different and has unexpectedly led to better consumer understanding of the functionality and purpose of a watch exchange interface 200.

Box 205 shows a watch image 210 centered horizontally in the box. Directly below image 210 are buy option 225 and sell option 230, closely spaced together. Options 225 and 230 are preferably spaced together at a distance no greater than the width of option 225 and/or option 230, more preferably no greater than half the width, most preferably no greater than one-fourth the width. Directly above buy option 225 and sell option 230 are buy price 226 and sell price 231, respectively. Buy price 226 and sell price 231 are the prices at which the owner and/or manager of interface 200 is willing to purchase and sell a particular watch type, as identified by image 210 and title 215. Title 215 is located directly below buy option 225 and sell option 230. Title 215 provides a summary of information that identifies the watch depicted in image 210. In embodiments in which interface 200 is displayed on a monitor screen via a network, title 215 preferably comprises a link that sends the consumer to another interface that displays additional details about the watch shown in image 210. In other embodiments a detailed description of the watch shown in box 205 could be shown directly below title 215.

Box 205 is one of six boxes that are horizontally displayed in interface 200. Interface 200 could include any number of boxes per horizontal row. Furthermore, interface 200 could include multiple rows for displaying a plurality of watches.

The size of image 210 is about ten times larger than the size of buy option 225 and sell option 230. The large size of image 210 with respect to other information presented on interface 200 allows a user to readily identify a watch of interest using the watch's visual features. In alternative embodiments, the size of image 210 is adjusted (i.e., decreased or increased) as a function of a class of users (e.g., age, watch trading experience, etc).

FIG. 3 shows a search tool 300 for searching a database of watches. Type selection 305 and model selection 310 provide drop-down menus that allow a consumer to select a specific watch type and model. Search tool 300 could also include filters other than type and model. For example, drop-down menus could be included for watch color, size, condition, source, etc.

Search tool 300 also includes a buy option 315 and a sell option 320, which allows a consumer to send a query to a database of watches and will provide a set of results that best fits the selection criteria established by the consumer.

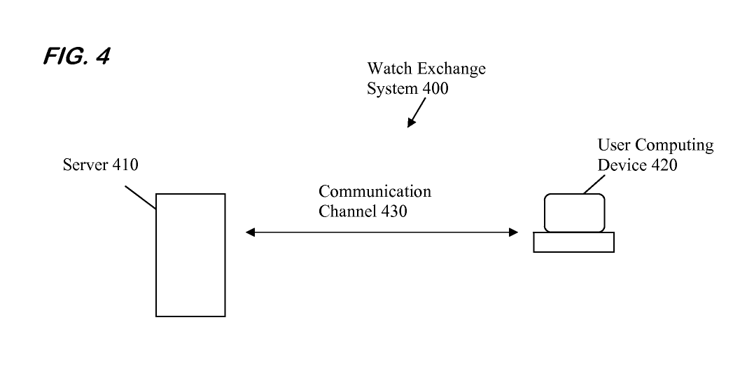

FIG. 4 shows a system 400 for providing interface 200 (See FIG. 2 above). System 400 comprises a server 410, a user computing device 420, and an electronic communication channel 430. Server 410 includes an electronic storage medium (e.g., hard drive, database), a processor communicatively coupled with the storage medium, and executable code (e.g., software instructions). Server 410 is configured to store watch objects (e.g., data relevant to buying and selling watches). The executable code is configured display the watch objects to a consumer in the manner shown in interface 200. The consumer can access interface 200 via a user computing device 420 (e.g., a smart phone, laptop, personal computer) and via communication channel 430 (e.g., WAN, LAN, wireless protocol, etc). In one embodiment, communication channel 430 includes an internet connection and server 410 displays interface 200 on device 420 via a web portal.

Servers, web portals, computing devices, and electronic communication channels are well known and any combination of devices, technologies, and protocols suitable for displaying interface 200 to a consumer are contemplated. Server 410 can comprise multiple servers with distributed processing responsibilities. The storage medium could comprise a central database or a distributed virtual database located on multiple devices in remote locations.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A system for buying and selling watches comprising:
a storage medium that contains a plurality of watch objects;
a processor communicatively coupled with the storage medium;
executable code communicatively coupled with the processor and configured to present a subset of the watch objects to a user via an interface;
wherein the subset of watch objects includes an image, title, buy price, sell price, buy link, and sell link; and
wherein the subset of watch objects are displayed as follows:
the buy price and sell price are presented side-by-side and spaced apart by a distance no greater than either length of the buy price and sell price;
the buy price and sell price are located directly below the image; and
the buy link and sell link are located directly below the buy price and sell price, respectively.

2. The system of claim 1, wherein the storage medium is connected to a network.

3. The system of claim 1, wherein the storage medium is distributed across at least two separate hardware devices.

4. The system of claim 1, wherein the subset of watch objects further includes an item number, model number, quantity of watches in inventory, condition, source, year of manufacture, date entered into inventory, chain of title verification, and customer reviews.

5. The system of claim 1, wherein the buy link and sell link comprise a first hyperlink that directs a user to a buy interface and a second hyperlink that directs a user to a sell interface, respectively.

6. The system of claim 5, wherein the buy interface and sell interface are configured to assist a consumer in buying and selling a used watch, respectively.

7. The system of claim 1, wherein the buy price and sell price are spaced apart by a distance less than 4 mm.

8. The system of claim 1, wherein the vertical space between the image and the buy price and sell price contains no other watch object.

9. The system of claim 1, wherein the title is located directly below the buy link and sell link.

10. The system of claim 1, wherein the buy price and buy link are presented in a first color and the sell price and sell link are presented in a second color that is different than the first color.

11. An electronic interface for displaying information relating to used watches comprising:
a buy price and a sell price presented side-by-side and spaced apart by a distance no greater than either length of the buy price and sell price;
an image presented directly above the buy price and sell price; and
a buy link and a sell link located directly below the buy price and sell price, respectively.

12. The interface of claim 11, wherein the buy price is located to the left of the sell price.

13. The interface of claim 11, wherein the buy price and buy link are presented in a first color and the sell price and sell link are presented in a second color that is different than the first color.

14. The interface of claim 11, further comprising a title located directly below the buy link and sell link.

15. The interface of claim 11, wherein a maximum vertical length of the image is at least ten times greater than a maximum vertical length of the buy link and sell link.

16. The interface of claim 11, wherein the image is a front view of a watch.

17. The interface of claim 11, wherein the image is a perspective view of a watch.

18. The interface of claim 11, wherein the image is a photograph of an actual watch.
